(19) United States
(12) Patent Application Publication
(10) Pub. No.: US 2007/0050257 A1
(43) Pub. Date: Mar. 1, 2007

(54) ONLINE PUBLISHING AND MANAGEMENT SYSTEM AND METHOD

(75) Inventors: Robert Fine, Harriman, NY (US); Bruce W. Bolger, Hastings on Hudson, NY (US); James Kilmetis, Commack, NY (US)

Correspondence Address: ANTHONY R. BARKUME, 20 GATEWAY LANE, MANORVILLE, NY, 11949, US

(73) Assignee: SELLING COMMUNICATIONS, INC., Irvington, NY (US)

(21) Appl. No.: 11/423,107

(22) Filed: Jun. 8, 2006

Related U.S. Application Data
(63) Continuation of application No. 09/716,134, filed on Nov. 17, 2000, now abandoned.

(51) Int. Cl. G06Q 30/00

(52) U.S. Cl. 705/14

(57) ABSTRACT

The present invention is an online publishing management system and method that includes at least one advertisement computer means for storing an advertisement file; at least one article computer means for storing an article file; and a publishing management server computer. The publishing management server computer includes user interface means for receiving data from and sending data to user, database means for storing a plurality of database tables, and processing means. The database tables include an advertisement table having a plurality of advertisement records, each advertisement record having information regarding an advertisement file stored on an advertisement computer means; an advertiser table having a plurality of advertiser records, each advertiser record having information regarding an advertiser associated with at least one advertisement file stored on an advertisement computer means; and an article table having a plurality of article records, each article record having information regarding an article file stored on an article computer means. The processing means is adapted to generate a plurality of reports as a function of one or more of the database tables; allow a user to input, via the user interface means, criteria for generating the reports; provide the reports to a user via the user interface means; and allow a user to enter or modify, via the user interface means, records in any of the database tables.

### BACKGROUND OF THE INVENTION

This invention relates to an online and print publishing management system that allows users to integrate publishing management functions, such as report generation, via the Internet.

Currently, many publishers are experimenting with Web sites offering news and banner ads. Many are finding that these sites increase subscription solicitation costs by making it too easy for readers to get news without subscribing, and are failing to generate significant revenue because of drawbacks with the banner ad/clickthrough model. Most publishers outside of the computer software business that have experimented with generating transaction fees on e-commerce sales have failed to generate significant revenues through commissions.

In addition, publishers already manage myriad functions on separate software platforms that don't talk to one another. This makes it even more difficult to undertake Web ventures, because it is already time-consuming enough for separate publishing divisions to manage and get real-time information about advertisers, contracts and advertisements; content, authors, and copyrights; subscribers and renewal notices; reader surveys, and buyers' guides.

It is therefore desired to provide a system that allows an authorized manager to manage all aspects of print and Internet publishing on a single Web-based platform and get critical, real-time information about any functional area.

Many brick and mortar companies with Web sites are frustrated with the inability to know who actually visits their Web sites and are seeking to use the Internet as a database, relationship-building tool. The present invention makes it affordable for almost any size company to create a buyer's catalogue along with a special, registration-only portion of their Web site that uses content, special pricing, incentives, etc., to get people to register to receive future offers and newsletters by print or e-mail.

Any organization that has even a single Web site, newspaper, magazine or newsletter can benefit from the present invention, and the more newspapers, newsletters and magazines, and Web sites published, the more it can benefit.

### SUMMARY OF THE INVENTION

The present invention is an online publishing management system that includes at least one advertisement computer means for storing an advertisement file; at least one article computer means for storing an article file; and a publishing management server computer. The publishing management server computer includes user interface means for receiving data from and sending data to a user, database means for storing a plurality of database tables, and processing means. The database tables include an advertisement table having a plurality of advertisement records, each advertisement record having information regarding an advertisement file stored on an advertisement computer means; an advertiser table having a plurality of advertiser records, each advertiser record having information regarding an advertiser associated with at least one advertisement file stored on an advertisement computer means; and an article table having a plurality of article records, each article record having information regarding an article file stored on an article computer means. The processing means is adapted to generate a plurality of reports as a function of one or more of the database tables; allow a user to input, via the user interface means, criteria for generating the reports; provide the reports to a user via the user interface means; and allow a user to enter or modify, via the user interface means, records in any of the database tables.

Additionally, the database tables may further include an author table having a plurality of author records, each author record having information regarding an author associated with at least one article file stored on an article computer means.

The database tables may also include a partner table having a plurality of partner records, each partner record having information regarding a partner of the system, and/or a subscriber table having a plurality of subscriber records, each subscriber record having information regarding a subscriber of the system.

The processing means may be further adapted to generate a composite article for publication to a subscriber; the composite article comprising an article file and at least one advertisement reference associated therewith. In this event, the composite article may be in HTML code, and the associated advertisement reference is a resource locator (e.g. a URL) of an advertisement associated with the composite article.

The reports generated by the processing means may include an advertiser contract report having a list of contract records for an advertiser of the system, the contract records including a description of the advertiser, a description of the advertisement associated with the advertiser, a field indicative of the start date and the end date of the advertisement, and a field indicating an article that the advertisement is associated with and the display position within that article.

The reports generated by the processing means may include an advertiser lead report including a list of advertiser lead records, each advertiser lead record having an identification of a subscriber, a list of articles previously accessed by that subscriber within a defined time period, and a list of advertisements associated with those articles previously accessed by that subscriber within a defined time period.

The reports generated by the processing means may also include an article usage report having a list of articles and the number of subscribers that accessed each article in a given time period. The reports may also include an article activity report having a list of articles and activity statistics, the activity statistics including the number of times the article was viewed, the number of times the article was printed, and the number of times the article was emailed.

In addition, improvements include the ability to track print (as well as Internet) advertisers, advertisements, advertising contracts, content, authors, and copyrights on the same above platform; to share information between departments, so that editors can see what advertisements look like before placing editorials; the marketing department can get easy access to subscriber and advertiser databases; the sales department can quickly see what ads are in inventory or how many subscribers meet specific buying criteria, etc. Improvements also include the ability to easily exchange databases or portions of databases between publishing partners; to automatically bill and notify sales management and both Internet and print advertisers when contracts expire; and to enable credit-card based access to detailed information, such as car repair manuals. The system will track archived print (along with Internet) articles in a format ready for resale or reuse via print or Internet applications; track forward bookings of advertising space; manage and track author/freelance payments; integrate advertiser information with popular sales contact management programs; integrate print and Internet publication subscriber databases; and manage digitized radio, television, and streaming video advertising on the same above platform.

Moreover, the invention can track the names and full demographic information of people who click from banner ads to Web sites.

### BRIEF DESCRIPTION OF THE DRAWING

FIG. 1 is a block diagram of the system topology of the invention;

FIG. 2 is a dataflow diagram that shows the relationships between the various tables utilized by the present invention;

FIG. 3 is a data flowchart that shows the initial contact and redirection steps;

FIG. 4 is a flowchart that shows the advertising display steps;

FIG. 5 is a flowchart that shows the click recording steps;

FIG. 6 is a flowchart that shows the table of contents display steps;

FIG. 7 is the web page for Add or Find an Advertiser;

FIG. 8 is the web page for Add an Advertiser;

FIG. 9 is an example of an Advertiser Contract Report;

FIG. 10 is an example of an Article Usage Report.

### DETAILED DESCRIPTION OF THE PREFERRED EMBODIMENT

The present invention is a system that provides for print and Internet publishers to develop any content-driven or e-commerce Web strategy in a way that works with the printed products. The invention makes it easy to control on a single, easy-to-use platform every element of Internet publishing in a way that meshes cleanly with a print operation, including:

1) archiving searchable content by topics, including when it ran, where it ran (both in print and Internet publications), and other data including authors and copyright information and syndication information;

2) making it easy to place and track banner and display advertising so that advertisers can have ads adjacent to related news or other topics;

3) maintaining registered-user accesses or subscriptions (unpaid or paid), and easily tracking precise registered or nonregistered accesses to each article, including the identity of those who printed or e-mailed articles to colleagues;

4) maintaining online, searchable databases of products, services, calendars, resources, etc. that can be used for e-commerce or promoting e-commerce of the advertisers;

5) easily creating online surveys and benchmark studies;

6) letting readers electronically update their print/Internet subscriptions;

7) enable advertisers to electronically access own advertising reports, including demographics of article readership or even the names of the readers, if desired.

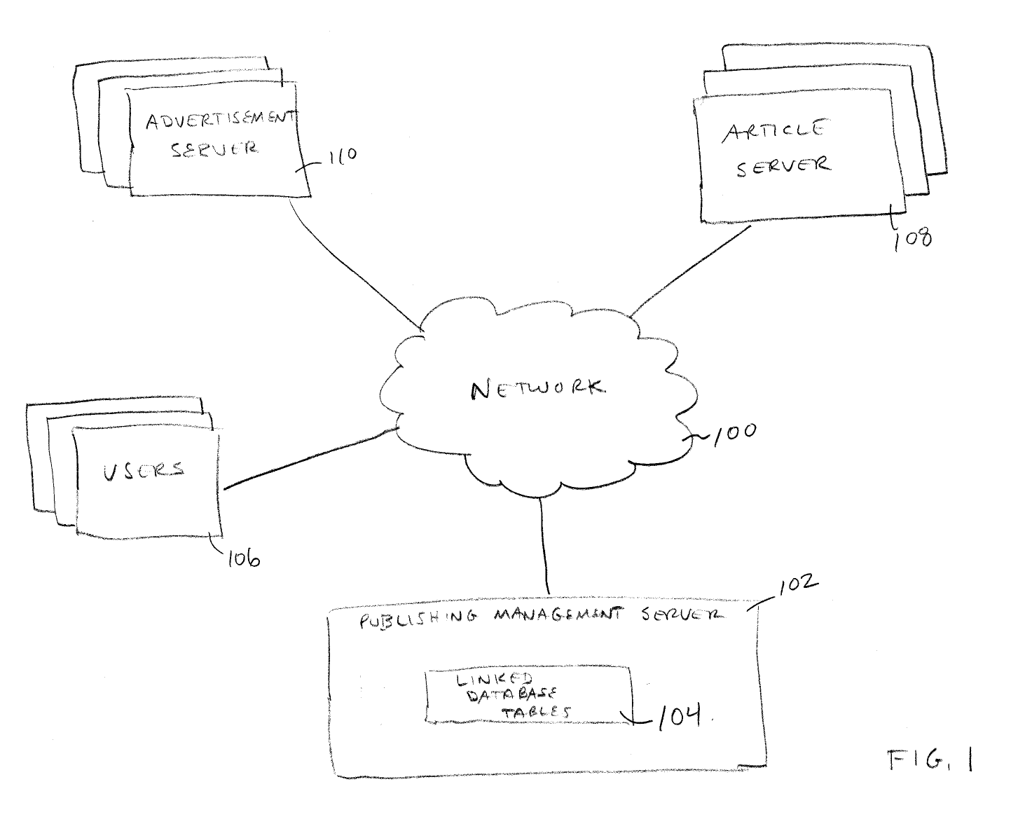

Referring to FIG. 1, the system of the present invention (commercial name “Press2Web”) is shown in top level block diagram format. A network 100, such as the Internet, is used to allow communication between various computers that are interconnected thereto. A publishing management server 102 contains a database of tables 104 that are linked as described herein; these tables contain the various data records that relate to users, subscribers, advertisers, advertisements, authors, and the like. Authorized users such as system administrators may be given access to the management server 102 over the Internet to allow entry of data into the appropriate tables, editing of records, as well as report generation to be described herein.

FIG. 1 also illustrates an article server(s) 108, which are used to store the various articles that are published by the system. Importantly, the articles may reside anywhere in the system (including on the management server), as long as they can be referenced by a resource locator such as a URL for publication. Likewise, an advertisement server(s) 110 is accessed by the system, and is used to store the advertisement files that are published along with the articles.

FIG. 1 also illustrates user computer(s) 106, wherein the users may be readers (subscribers) that will obtain the publications as desired. The management system tracks the users, the articles read, etc. to aid in report generation in accordance with this invention.

When a user logs onto the administrative web site hosted by the publishing management server 102, he is presented with a main web page that provides several groups of navigational buttons labeled MAIN TABLES, REPORTS, OTHER TABLES, CATALOG, and SYSTEM.

Main Tables

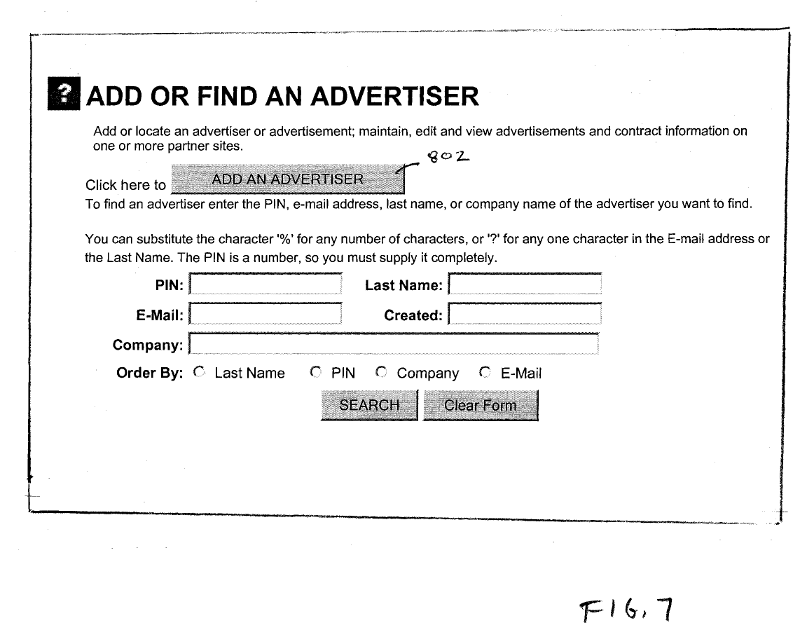

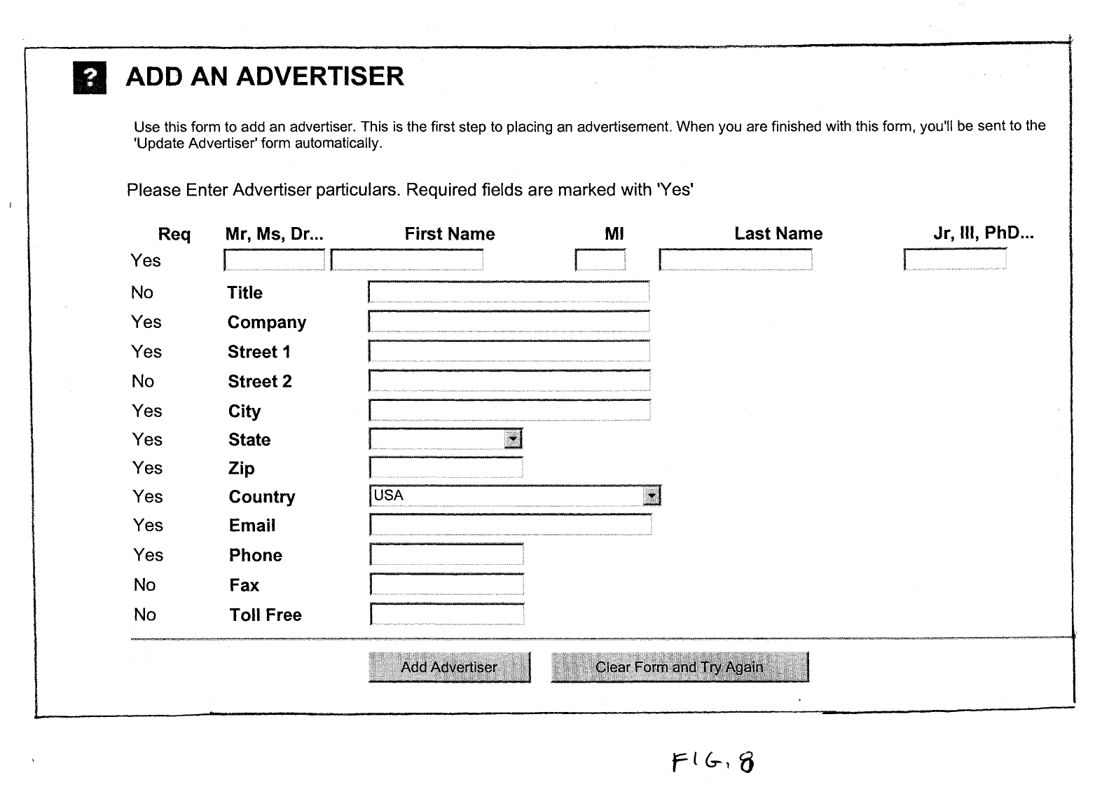

The MAIN TABLES navigational buttons include Advertisers, Articles, Authors, Partners, and Subscribers. Selection of the Advertisers button provides an Advertiser web page that allows the user to add or find a certain advertiser on the appropriate database table, as shown in FIG. 7. Selection of an “Add Advertiser” button 802 provides a web page as shown in FIG. 8 that allows the user to enter information on a new advertiser, such as name, address, email, phone number, etc., which will be added to the advertiser database table. In the alternative, the user may search the database for an existing advertiser record by entering various search criteria into the form (e.g. name, email address, company name) and returning the web page to the server via search button 804, which will perform the search and provide the appropriate results.

Selection of the Articles button provides a web page that allows the user to add or find a certain article on the appropriate database table. Selection of an “Add An Article” button provides a web page that allows the user to enter information on a new article, such as title, URL (location of article on the web), copyright information, summary of article, whether it is to be included in a Table of Contents, and whether an ID will be required for access by a reader, which will be added to the article database table. In the alternative, the user may search the database for an existing article record by entering various search criteria into the form (e.g. title, URL, or ID number)) and returning the web page to the server, which will perform the search and provide the appropriate results. This functionality is similar to the functionality described for Advertisers above, with reference to FIGS. 7 and 8.

Selection of the Authors button provides a web page that allows the user to add or find a certain author on the appropriate database table. Selection of an “Add Author” button provides a web page that allows the user to enter information on a new author, such as name, address, email, phone number, the URL of a photo, and biography information, which will be added to the advertiser database table. In the alternative, the user may search the database for an existing author record by entering various search criteria into the form (e.g. name, email address) and returning the web page to the server, which will perform the search and provide the appropriate results. This functionality is similar to the functionality described for Advertisers above, with reference to FIGS. 7 and 8.

Similarly, the user may select a Partner button or a Subscriber button, each of which will provide web pages for searching or adding partners or subscribers in the same manner as described above.

Reports

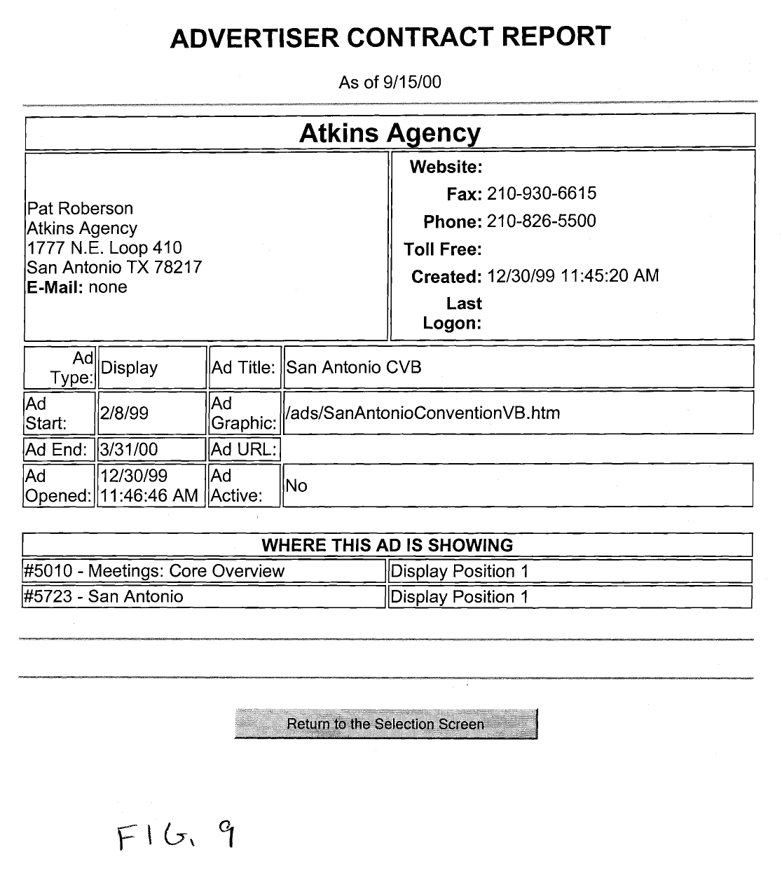

The REPORTS navigational buttons include Advertisers, Articles, and Partners. Selection of the Advertisers button provides the user with the option to select a Contracts report page, a Leads report page, a Positions report page, or a Click Through report page. The Contracts report page provides a scroll list that allows the user to select an advertiser, after which a report is generated by the server that will list each contract for that advertiser, including contact information, the Ad Start Date, the Ad End Date, the URL of the advertisement, the articles in which the advertisement is placed (and the position therein), and, if desired the advertisement itself. An example of an Advertiser Contract Report is shown in FIG. 9.

The Leads report page allows the user to view and print registered readership by advertiser. Thus, by specifying the beginning and ending dates as well as the advertiser, the user will be provided with the appropriate data in report format. The report will list, for each article, the name, address, email, etc. for each user that has accessed that article.

The Positions report page allows the user to view and print advertisements and advertisement positions by advertiser and date. Thus, by entering the beginning date, end date, and desired advertiser, the user will obtain a report accordingly.

The Click Through report page provides the user with an Advertisement Click Count Report. This provides the user with counts of click-throughs from tracked links, articles and advertisements where the hyperlink was not entered in the article database but tracking was turned on at the link. The report will show the advertisement and number of click-throughs for a given date.

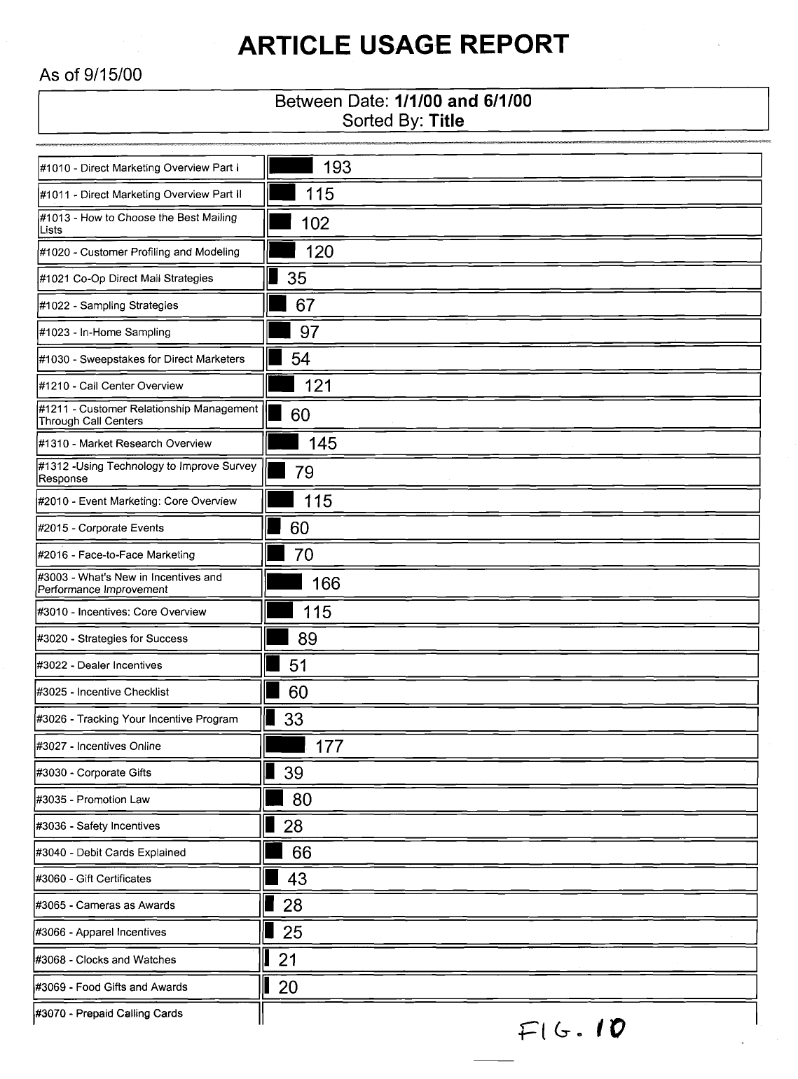

Selection of the Articles button provides the user with the option to select a Usage report page, an Activity report page, or a Leads report page. The Usage report page will provide a Comparative Article Usage Report, which will allow the user to view relative activity of each article or section of his site (or content ranked by activity). Thus, by entering a beginning date and an end date, and selecting a sort by article title or usage, the number of hits for each article is shown in bar graph format. An example of the Article Usage Report is shown in FIG. 10.

The Activity report page will provide an Article Activity and Statistics Report, which will allow the user to view article activity by number of registered users and nonregistered users, as well as by the number of people who used the used the print and email referral feature. Thus, by entering a beginning date and end date, each Article Title is shown along with the View Count, Print Count, Email Count (Known and Unknown) for each article.

The Article Leads report page allows the user to view and print registered readership by article. Thus, by specifying the beginning and ending dates as well as the article, the user will be provided with the appropriate data in report format. The report will list, for each article, the name, address, email, etc. for each user that has accessed that article.

Selection of the Partners button allows the user to access reports on Partner Activity and Partner Leads, which are similar to those set forth above.

The publishing management server comprises a database such as a SQL database or the like that includes various tables used to store information for the present invention. The tables are provided as follows:

Table Descriptions

Adartpos

This table contains the combined information about advertisements, articles, and positions. It allows the publishing of a particular advertisement in any number of articles, in any position therein, and in the case of banner (graphic) advertisements, the horizontal and vertical size as well as the border width.

Two specialized types of records are contained in this table. The first is the record containing information necessary to place an advertisement in a system generated table of contents by topic. The second is the information necessary to place an advertisement in a key word search.

| Field Name | Type | Description |
|---|---|---|
| ap_id | decimal | System generated unique record key. |
| | | Used to identify one ad placement |
| | | against all others. |
| ap_pa_id | float | Ad position ID, from the POSITION |
| | | table. |
| ap_art_id | float | Article ID from the ARTICLES table |
| ap_ad_id | float | Advertisement ID, from ADVERTS, |
| | | indicates what ad to display in what |
| | | position in what article. |
| ap_lastview | datetime | System maintained date and time ad |
| | | was last served. When more than |
| | | one ad is in the same position in |
| | | an article, this time is used to |
| | | serve the one with the oldest |
| | | last view. |
| ap_view_ct | float | A counter for each time the |
| | | advertisement is served. This can |
| | | be reset by the advertiser, since |
| | | actual counts come from the number |
| | | of entries in USAGELOG |
| ap_click_ct | float | A counter for each time the |
| | | advertisement is clicked when the |
| | | advertisement is a banner ad. |
| | | This can be reset by the |
| | | advertiser, since actual counts |
| | | come from the number of entries |
| | | in USAGELOG |
| ap_height | float | If the advertisement is a banner |
| | | ad, this will cause the graphic |
| | | to be displayed at this height - |
| | | note that for each ad |
| | | position in this table, the same |
| | | advertisement can be shown in a |
| | | different size to match the |
| | | document it's displayed in. |
| ap_width | float | If the advertisement is a banner |
| | | ad, this will cause the graphic |
| | | to be displayed at this width - |
| | | note that for each ad position |
| | | in this table, the same |
| | | advertisement can be shown in |
| | | a different size to match the |
| | | document it's displayed in. |
| ap_border | float | If the advertisement is a banner |
| | | ad, this will cause the graphic |
| | | to be displayed with this |
| | | border - note that for each ad |
| | | position in this table, the same |
| | | advertisement can be shown with |
| | | different border to match the |
| | | document it's displayed in. |
| ap_ak_id | float | For keyword (or search) |
| | | advertising, this ID from |
| | | the ADKEYWORDS table indicates |
| | | the ad to server for the search |
| | | results. When this is not zero, |
| | | the information is used |
| | | instead of the ap_id. |

Adkeywords

This table contains the actual keyword linked in the keyword search.

| Field Name | Type | Description |
|---|---|---|
| ak_id | float | System generated unique key. |
| ak_keywords | varchar (255) | Key words or phrase that is used to |
| | | determine what, if any, advertisement |
| | | to show with a search result. |

ADKEYWORDS_XREF

This table contains the cross reference between the keyword and the advertisement associated with it. One advertisement can be associated with many keywords, and many advertisements can be associated with one keyword. The system automatically displays the one that has not been seen for the longest time.

| Field Name | Type | Description |
|---|---|---|
| ak_id | float | Keyword ID from the ADKEYWORDS table |
| ad_id | float | Advertisement ID from the ADVERTS table |

ADVERTISERS

The advertiser table contains basic advertiser information including address and contact information.

| Field Name | Type | Description |
|---|---|---|
| av_pinnum | float | System generated unique key for |
| | | each advertiser. |
| av_userid | char (20) | Advertiser user ID that is one part |
| | | of the ID/Password combination |
| | | needed to get individual reports |
| | | through the Advertisers Information |
| | | Subsystem. It defaults to the |
| | | advertiser's contact last name. |
| | | It can be changed by the |
| | | Press2Web ™ administrator. |
| av_password | char (10) | Advertiser Password, the other part |
| | | of the ID/Password combination. It |
| | | defaults to the AV_PINNUM, but |
| | | can be changed by the advertiser. |
| av_prefix | char (10) | Contact prefix, such as Mr, Mrs, |
| | | Ms, or Dr. |
| av_fname | char (15) | Contact first name |
| av_mi | char (2) | Contact middle initial(s) |
| av_lname | char (20) | Contact last name. |
| av_suffix | char (10) | Contact suffix, such as Jr, PhD, |
| | | etc. |
| av_title | varchar (50) | Contact title |
| av_company | varchar (50) | Advertiser's company name |
| av_addr1 | char (40) | Advertiser's street address, |
| | | line 1 |
| av_addr2 | char (40) | Advertiser's street address, |
| | | line 2 |
| av_city | char (20) | Advertiser's city. |
| av_province | char (10) | Advertiser's state or province |
| av_country | char (20) | Advertiser's country |
| av_postal | char (20) | Advertiser's postal/zip code |
| av_website | varchar (200) | Advertiser's web site url |
| av_email | varchar (200) | Advertiser's e-mail address. |
| av_fax | char (20) | Advertiser's fax number |
| av_phone | char (20) | Advertiser's phone number |
| av_tollfree | char (20) | Advertiser's toll free number |
| av_opendt | datetime | Date advertiser record was created. |
| | | System generated |
| av_lastondt | datetime | Date the advertiser last used the |
| | | Press2Web ™ Advertiser |
| | | Information System |

ADVERTS

The adverts table contains information about the advertisements, including the advertiser it belongs to, the type of advertisement it is, its starting and ending date, and when the advertiser should be called to renew the advertisement contract.

| Field Name | Type | Description |
|---|---|---|
| ad_id | float | System generated unique advertisement |
| | | ID. |
| ad_pinnum | float | Advertiser PIN, links this |
| | | advertisement to a particular |
| | | advertiser. |
| ad_type | char (1) | Type of advertisement, (D)isplay or |
| | | (B)anner. Determines how Press2Web ™ |
| | | displays the advertisement. |
| ad_title | Varchar (100) | Campaign name for this advertisement - |
| | | or just a title to give humans a break |
| ad_start | datetime | Date the advertisement can start |
| | | it's run - as of midnight of the |
| | | day indicated |
| ad_end | datetime | Date the advertisement stops running - |
| | | as of midnight of the day indicated |
| ad_renew | datetime | Date to remind Press2Web ™ owners |
| | | this advertiser needs to renew |
| | | advertisement contract |
| ad_graphic | varchar (200) | URL of the graphic to display or HTML |
| | | file to include when advertisement |
| | | is served. |
| ad_url | varchar (200) | If this is a banner advertisement, |
| | | this is the URL to go to when clicked. |
| ad_opened | datetime | System generated date when this record |
| | | was opened. |
| ad_active | bit | A flag to turn serving this |
| | | advertisement on and off, even if in |
| | | a current contract period (between |
| | | ad_start and ad_stop dates). |

ARTICLES

This table contains the information about articles served by Press2Web™, including the title shown on the table of contents, summary, copyright information other than the default, the url, and several switches that determine the articles status.

| Field Name | Type | Description |
|---|---|---|
| ar_id | float | System generated unique article |
| | | key. |
| ar_title | varchar (100) | Article title. |
| ar_summary | varchar (2048) | Article summary displayed on the |
| | | Table of Contents when using the |
| | | Press2Web ™ TOC tools. |
| ar_copyright | varchar (50) | If the copyright of this article |
| | | is different from the default, |
| | | Press2Web ™ will display the |
| | | contents of this field instead |
| | | of the default copyright. |
| ar_url | varchar (100) | The URL of the article |
| ar_is_new | bit | Flag to indicate this is a new |
| | | article - Press2Web ™ will |
| | | place a special graphic near |
| | | new articles in the Table of |
| | | Contents tools. |
| ar_is_active | bit | Flag to allow/disallow the |
| | | displaying of this article |
| ar_ct_id | float | |
| ar_opendt | datetime | System generated date the record |
| | | was created |
| ar_view_ct | float | System updated view count - this |
| | | can be reset by the Press2Web ™ |
| | | system administrator. The actual |
| | | total counts come from |
| | | USAGELOG entries |
| ar_last_view | datetime | System updated date and time |
| | | article was last viewed. |
| ar_inc_toc | bit | Indicates the article should be |
| | | included in the Table of |
| | | Contents. Press2Web ™ can |
| | | track articles other than those |
| | | in a TOC. |
| ar_record | bit | Flag to indicate to Press2Web ™ |
| | | that access to this article |
| | | should be recorded. |
| timestamp_column | binary (8) | System generated time stamp |
| ar_require_id | bit | Indcates to Press2Web ™ that |
| | | an article can only be seen by |
| | | a subscriber. (A login is |
| | | required to see the article) |

AUTHORS

The Authors table contains contact information for all the authors. Press2Web™ has the tools for displaying author information directly from articles.

| Field Name | Type | Description |
|---|---|---|
| au_auth_id | float | System generated unique author ID |
| au_prefix | char (10) | Contact prefix, such as Mr, Mrs, |
| | | Ms, or Dr. |
| au_fname | char (15) | Contact first name |
| au_mi | char (2) | Contact middle initial(s) |
| au_lname | char (20) | Contact last name. |
| au_suffix | char (10) | Contact suffix, such as Jr, PhD, |
| | | etc. |
| au_title | char (40) | Contact title |
| au_company | char (40 | Author's company name |
| au_addr1 | char (40) | Author's street address, line 1 |
| au_addr2 | char (40) | Author's street address, line 2 |
| au_city | char (20) | Author's city. |
| au_province | char (10) | Author's state or province |
| au_country | char (25) | Author's country |
| au_postal | char (10) | Author's postal/zip code |
| au_bio | varchar (2048) | A text field that may contain the |
| | | author's biographic information. |
| | | Press2Web ™ will display it |
| | | automatically if the appropriate |
| | | tool is used. |
| au_email | char (50) | Author's e-mail address. |
| au_photo_url | char (100) | If it is desired to display the |
| | | author's picture, this is the |
| | | path to that graphic. |

AUTHXREF

This table is the cross reference between the articles and authors. One author may write many articles. One article may also have multiple authors. Press2Web™ has the tools for creating author links on each article.

| Field Name | Type | Description |
|---|---|---|
| ar_id | float | Article ID from the ARTICLES table |
| auth_id | float | Author ID from the AUTHORS table |

BUSINESS

The business table contains the entries used for subscriber validation.

| Field Name | Type | Description |
|---|---|---|
| bs_id | float | System generated business ID |
| bs_name | varchar (50) | Description of the business. |

CATEGORY

The category table is used for grouping catalog products together by category.

| Field Name | Type | Description |
|---|---|---|
| cc_id | int | System generated unique category ID |
| cc_name | varchar (50) | Category name |
| cc_desc | varchar (1024) | Category description |
| cc_special | bit | Spare field used for custom applications |
| cc_opendt | datetime | System generated date record was created. |

ITEMCAT

This is the cross-reference table that links a catalog item with categories—one item can belong to several categories; one category can contain several items.

| Field Name | Type | Description |
|---|---|---|
| ci_id | int | Category item ID from CAT_ITEMS table |
| cc_id | int | Category ID from CATEGORY table |

ITEMPROG

This cross-reference table links catalog items with the incentive program they belong to—one item can belong to several programs; one program can contain several items.

| Field Name | Type | Description |
|---|---|---|
| ci_id | int | Category item ID from CAT_ITEMS table |
| cp_id | int | Program ID from CAT_PROGRAM table |

CAT_ITEMS

The main catalog table containing all the information associated with a product including pricing, description, and image url.

| Field Name | Type | Description |
|---|---|---|
| ci_id | int | System generated unique catalog |
| | | item ID. |
| ci_name | [varchar (50) | Item name |
| ci_desc | varchar (1024) | Item description |
| ci_retail_price | float | Item retail price |
| ci_whsle_price | float | Item wholsale price |
| ci_distrib_price | float | Item distributor price |
| ci_graphic | varchar (50) | The URL of the picture of the |
| | | item for Press2Web ™ to display |
| ci_url | varchar (100) | The URL to jump to if the picture |
| | | is clicked on |
| ci_height | int | Height to display the graphic |
| ci_width | int | Width to display the graphic |
| ci_border | int | Border width to put around graphic |
| ci_mfg_item_no | varchar (50) | Manufacturer's item number |
| ci_opendt | datetime | System generated date this record |
| | | was created |

CAT_PROGRAM

This is the catalog item program table. It is linked to the items through the ITEMCAT table. Programs are used to group items.

| Field Name | Type | Description |
|---|---|---|
| cp_id | int | System generated unique ID for this program |
| cp_name | varchar | Name of the program |
| | (50) | |
| cp_opendt | datetime | System generated date this record was created |

COUNTRY

This is the country table. It is used for validating the addresses for subscribers, partners, authors, and advertisers.

| Field Name | Type | Description |
|---|---|---|
| cy_name | char (30) | Name of this country |
| cy_id | int | System generated unique ID for this country |

GROUPS

Groups are a totally artificial method of linking subscribers together. Used only by Press2Web™ administrators.

| Field Name | Type | Description |
|---|---|---|
| gp_id | float | System generated unique group ID |
| gp_name | varchar (50) | Name of the group |

GROUPXREF

This table links the subscribers to the group table—a subscriber can belong to several groups; a group contains one or more subscribers.

| Field Name | Type | Description |
|---|---|---|
| sb_pinnum | float | Subscriber PIN, from SUBSCRIBERS table |
| gp_id | float | Group ID from GROUPS table |

NEWSLETTERS Press2Web™ can manage the subscriptions to e-mail newsletters. This is the table that contains the newsletters managed.

| Field Name | Type | Description |
|---|---|---|
| nl_id | float | System generated unique Newsletter ID |
| nl_name | varchar (50) | Newsletter name or title |

NEWSXREF

This table is the cross reference between subscribers and newsletters. A subscriber can subscribe to any number of newsletters; newsletters can have any number of subscribers.

| Field Name | Type | Description |
|---|---|---|
| sb_pinnum | float | Subscriber PIN, from SUBSCRIBERS table |
| nl_id | float | Newsletter ID from NEWSLETTERS table |

NEXTKEY

Each table contains a master (unique) key id. Although it is possible to have SQL server generate a key, the key is only known after a record is saved. Using a stored procedure to generate a key beforehand, nothing has to be written to the databases until a record is actually saved. In a highly interactive, web-based data management system, this is the preferable way. This is a Press2Web™ internally managed table and should never be changed by end users.

| Field Name | Type | Description |
|---|---|---|
| key_name | char] (10) | Unique key name. |
| key_value | float | Current key value |
| key_incr | float | Number to increment key_value by before |
| | | returning new key. |

P2W_ERRORS

In an effort to make errors more understandable to the end user, Press2Web™ contains a rudimentary error reporting system that attempts to let the user know what's wrong and how they can recover from the problem. This is an internal Press2Web™ table that should never be changed by end users.

| Field Name | Type | Description |
|---|---|---|
| er_id | char (10) | Unique error ID. |
| er_message | varchar (1024) | Error message to display. |
| er_solution | varchar (1024) | Solution message to display |
| er_opendt | datetime | System generated date record was created. |

PARTNERS

Partners are companies other than the web site owner that can use any number of the articles associated with Press2Web™. Partnering offers content to website owners that they don't have to maintain, and offers advertisers new formats for their advertising. Partnering also offers a revenue stream for the Press2Web™ owner by charging advertisers by partner site. Partner sites can have their own look and navigation. The partner table contains information about the partner and several switches that tell Press2Web uses for article displays.

| Field Name | Type | Description |
|---|---|---|
| pt_id | float | System generated unique partner ID |
| pt_name | char (50) | Partner name. This is used wherever |
| | | the partner name is displayed on |
| | | the web. Very often the name |
| | | displayed is different from the |
| | | company name. |
| pt_prefix | char (10) | Contact prefix, such as Mr, Mrs, |
| | | Ms, or Dr. |
| pt_fname | char (15) | Contact first name |
| pt_mi | char (2) | Contact middle initial(s) |
| pt_lname | char (20) | Contact last name. |
| pt_suffix | char (10) | Contact suffix, such as Jr, PhD, |
| | | etc. |
| pt_company | char (40) | Partner company name |
| pt_title | char (40) | Contact title |
| pt_addr1 | char (40) | Partner's company name |
| pt_addr2 | char (40) | Partner's street address, line 1 |
| pt_city | char (25) | Partner's street address, line 2 |
| pt_province | char (10) | Partner's city. |
| pt_postal | char (10) | Partner's state or province |
| pt_country | char (20) | Partner's country |
| pt_phone | Char (20) | Partner's phone number |
| pt_email | Char (50) | Partner's e-mail address |
| pt_comments | Varchar | Space for any comments the |
| | (2048) | Press2Web ™ users might want to |
| | | put about this partner. |
| pt_sourcecode | char (20) | Partner's source code - this |
| | | is the code that allows |
| | | Press2Web ™ to track activity |
| | | by partner - it is unique. |
| timestamp_column | Binary (8) | System maintained date and time |
| pt_password | char (20) | Partner's password - necessary |
| | | to get into the Press2Web ™ |
| | | Partner Information subsystem. |
| | | It can be changed as long as the |
| | | password/user id pair are unique. |
| pt_userid | char (10) | Partner's user ID - necessary |
| | | to get into the Press2Web ™ |
| | | Partner Information subsystem. |
| | | It can be changed as long as the |
| | | password/user id pair are unique. |
| pt_opendt | datetime | System generated date the partner |
| | | record was created. |
| pt_can_search | bit | Flag to indicate to Press2Web ™ |
| | | that subscribers entering through |
| | | this partner site can have access |
| | | to the index search function in |
| | | the article manager. |
| pt_can_print | bit | Flag to indicate to Press2Web ™ |
| | | that subscribers entering through |
| | | this partner site can have access |
| | | to the print function in the |
| | | article manager and the Top of |
| | | Page Press2Web ™ tool. |
| pt_can_email | bit | Flag to indicate to Press2Web ™ |
| | | that subscribers entering through |
| | | this partner site can have access |
| | | to the ‘e-mail a friend’ |
| | | function in the article manager |
| | | and the Top of Page Press2Web ™ |
| | | tool. |
| pt_can_toc | bit | Flag to indicate to Press2Web ™ |
| | | that subscribers entering through |
| | | this partner site can jump to the |
| | | Table of Contents in the Top of |
| | | Page Press2Web ™ tool. |

PF_CATEGORY

The Primary Function category table allows grouping of primary functions. For instance, President, CEO, CIO or CTO could all belong to a category ‘General Management’. This table is a validation table for categorizing Primary Functions. A primary function can only have one category.

| Field Name | Type | Description |
|---|---|---|
| pc_id | int | System generated unique key for this |
| | | primary function category |
| pc_descrip | varchar (50) | Primary function category description |
| pc_opendt | datetime | System generated date this record was |
| | | created |

POSITIONS

This table is for naming the positions advertisements can be placed in an article.

| Field | | |
|---|---|---|
| Name | Type | Description |
| pa_id | float | System generated unique advertisement |
| | | position ID |
| pa_name | varchar | Name of the advertisement position. |
| | (50) | |

PRIMARY_FUNCTION

This is the table for validating subscriber primary functions.

| Field Name | Type | Description |
|---|---|---|
| pf_id | int | System generated unique primary function |
| | | ID |
| pf_descrip | varchar (50) | Primary function description |
| pf_pc_id | int | Primary function category, used for |
| | | grouping primary functions, from the |
| | | PF_CATEGORY table. |
| pf_opendt | datetime | System generated date this record was |
| | | created |

PT_AD_XREF

This table contains records that indicate advertisements that should not be shown on a particular partner site. By default, Press2Web™ shows all advertisements on all partner sites. By adding a record in this table, advertisements can be suppressed from a partner site.

| Field Name | Type | Description |
|---|---|---|
| ad_id | float | Advertisement ID from ADVERTS |
| pt_id | float | Partner ID from PARTNERS table |

PT_AR_XREF

This table contains records that indicate articles that should not be shown on a particular partner site. By default, Press2Web™ shows all articles on all partner sites. By adding a record in this table, articles can be suppressed from a partner site.

| Field Name | Type | Description |
|---|---|---|
| pt_id | float | Partner ID from PARTNERS table |
| ar_id | float | Article ID from ARTICLES table |

QSUBS_*******

A partner can have, in addition to the basic demographic information, information collected specially for them. Each partner site will have a special table called ‘QSUB’ and the partner source code. If Press2Web™ detects this table, it will look for code to add to the registration form. If the code exists, this information will be gathered.

| Field Name | Type | Description |
|---|---|---|
| qs_pinnum | float | Subscriber PIN, used to link this record |
| | | to a subscriber. |
| qs_1 . . . n | Varies | These fields contain the answers from |
| | | subscribers with the appropriate source |
| | | code. Each partner can have its own |
| | | questionnaire beyond the default name |
| | | and address information required by |
| | | Press2Web ™. |

STATES

A table for validating states or provinces in all addresses.

| Field Name | Type | Description |
|---|---|---|
| abbrev | char (2) | State or province abbreviation |
| fullname | char (20) | Full state of province name |

SUBSCRIBERS

The subscriber table contains all the subscriber demographic information, including paid circulation data.

| Field Name | Type | Description |
|---|---|---|
| sb_pinnum | float | System generated unique ID for |
| | | this subscriber |
| sb_userid | char (20) | Subscriber's user ID, can be |
| | | changed by the user, but the user |
| | | id/password pair must be unique. |
| sb_password | char (10) | Subscriber's password, can be |
| | | changed by the user, but the user |
| | | id/password pair must be unique. |
| sb_prefix | char (10) | Contact prefix, such as Mr, Mrs, |
| | | Ms, or Dr. |
| sb_fname | char (15) | Contact first name |
| sb_mi | char (2) | Contact middle initial(s) |
| sb_lname | char (20) | Contact last name. |
| sb_suffix | char (10) | Contact suffix, such as Jr, PhD, |
| | | etc. |
| sb_title | varchar | Contact title |
| | (50) | |
| sb_company | varchar | Subscriber's company name |
| | (50) | |
| sb_addr1 | char (40) | Subscriber's company name |
| sb_addr2 | char (40) | Subscriber's street address, |
| | | line 1 |
| sb_city | char (20) | Subscriber's street address, |
| | | line 2 |
| sb_province | char (10) | Subscriber's city. |
| sb_country | char (20) | Subscriber's state or |
| | | province |
| sb_postal | char (20) | Subscriber's country |
| sb_email | varchar | Subscriber's e-mail address |
| | (200) | |
| sb_fax | char (20) | Subscriber's fax number |
| sb_phone | char (20) | Subscriber's phone number |
| sb_source | char (10) | Original partner source code |
| | | subscriber registered with |
| sb_opendt | datetime | System generated date this record |
| | | was created |
| sb_lastondt | datetime | Date subscriber was last logged |
| | | in - system updated. |
| sb_restrict | bit | Flag to indicate the subscriber has |
| | | paid to not have his name used. |
| | | Basically an indication of a paid |
| | | subscriber. Not currently in use. |
| sb_dont_use | bit | Flag to indicate the subscriber |
| | | should not be counted in the usage |
| | | statistics |
| sb_paid_sub | bit | Indicates subscriber is a paid one, |
| | | and is paid up. |
| sb_sub_pd_dt | datetime | Date subscriber paid |
| sb_sub_beg_dt | datetime | Subscription begin date |
| sb_sub_end_dt | datetime | Subscription end date |
| sb_sub_pd_amt | float | Amount paid |
| sb_pf_id | bit | Subscriber's primary function |
| | | code from the PRIMARY_FUNCTION |
| | | table. |

TOP_ADS_XREF

This table is used to place advertisements on the system generated table of contents. It contains the information about ad sizing, order (from top to bottom), and of course, the advertisement ID.

| Field Name | Type | Description |
|---|---|---|
| tp_id | float | Topic ID from the TOPICS table |
| ad_id | float | Advertisement ID from the ADVERTS table |
| ad_order | int | Order from top to bottom for the placement |
| | | of the advertisement |
| ad_height | int | Advertisement height, if different from the |
| | | default graphic |
| ad_width | int | Advertisement width if different from the |
| | | default graphic |
| ad_border | int | Advertisement border width |
| ad_align | char (10) | Advertisement alignment (TOP, MIDDLE, |
| | | BOTTOM, etc.) |
| tp_ad_key | float | System generated unique key for this record. |

TOPICS

Each article must belong to at least one (and possibly more) topic to be displayed in the system generated table of contents. This table contains the topic id, the display name when it is a simple name, or the html code to display in place of the simple name.

| Field Name | Type | Description |
|---|---|---|
| tp_id | float | System generated unique topic ID. |
| tp_name | char (50) | Topic name, displayed on the Table of |
| | | Contents when the tp_heading field is |
| | | empty. |
| tp_heading | varchar (1024) | The HTML code displayed at the |
| | | beginning of a topic instead of the |
| | | tp_name if filled in. |

TOPIXREF

This is the cross-reference table that links articles to topics. Every Press2Web™ managed article belongs to at least one topic; each topic can have any number of articles.

| Field Name | Type | Description |
|---|---|---|
| tp_id | float | Topic ID from the TOPIC table. |
| ar_id | float | Article ID from the ARTICLES table. |

USAGELOG

One aspect of the invention is to track and report on traffic to the site. This is the table that logs all the activity associated with a site—from views of articles and advertisements to actions taken, like printing or e-mailing an article.

| Field Name | Type | Description |
|---|---|---|
| access_dt | datetime | System generated date this record |
| | | was created |
| currsourceid | varchar (10) | Source code from the current user |
| origsourceid | varchar (10) | Not currently in use. |
| url | varchar (100) | URL requested through CLICK.ASP. |
| ar_id | float | Article ID from the ARTICLES table |
| av_pinnum | float | Advertiser PIN when this record is |
| | | about an advertisement. |
| sb_pinnum | float | Subscriber PIN when known, or zero |
| | | if not. |
| pt_id | float | Partner ID from PARTNERS table - |
| | | this ID goes with the currsourceid. |
| ad_id | float | Advertisement ID from the ADVERTS |
| | | table through the ADARTPOS table |
| | | when this record is about an |
| | | advertisement |
| action | Varchar (10) | What action this record |
| | | represents - VIEW, PRINT, EMAIL, |
| | | SEARCH, or CLICK. |

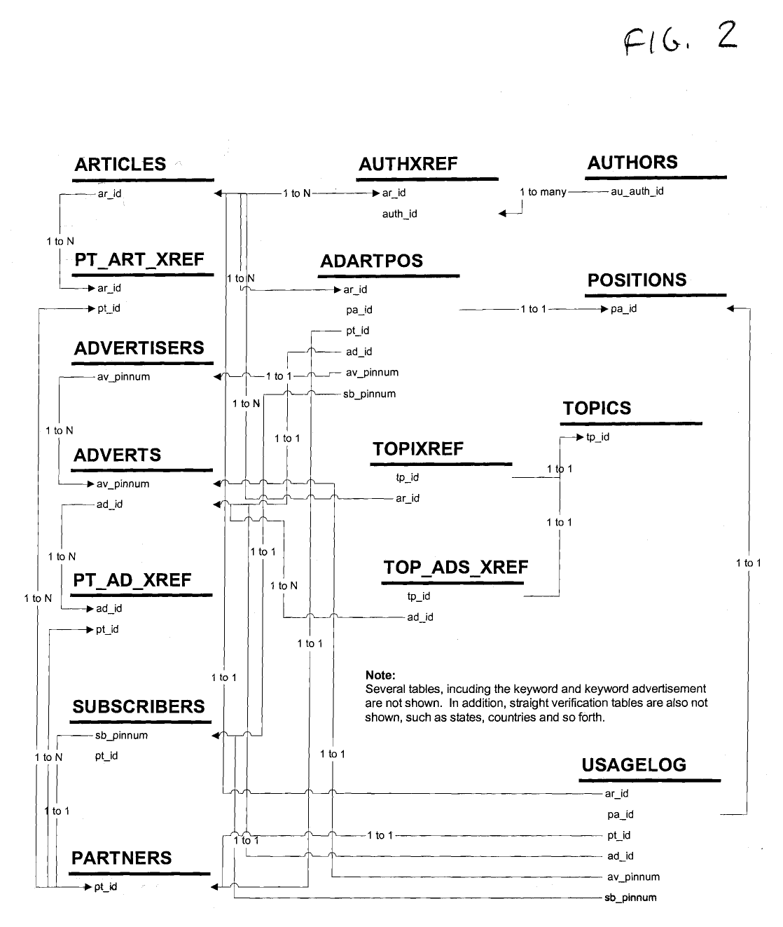

FIG. 2 illustrates the data relationships and linkages between the various tables in the management server. In the figure, relationships are indicated by lines with arrowheads pointing from the parent table to the child table. On the line may be a label indicating the type of relationship as follows:
1. 1 to 1 indicates that there is one row in the child table for each row in the parent table.
2. 1 to N indicates that for each row in the parent table there can be none to any number of rows in the child table.
   The only columns shown on the diagram are the columns involved in relationships.

Two tables, ADARTPOS and USAGELOG, are the main tables for the system. ADARTPOS is the table that stores information about the placement of advertisements in the articles. It is driven by ADVERTS, ARTICLES, and POSITIONS. Each row contains data about an advertisement placement in an article in a particular position.

USAGELOG is where all activity tracked on the site is recorded. It is driven by the date and time, the subscriber, what the subscriber has requested or what article or advertisement has been displayed or clicked.

The rest of the tables provide a means of ensuring ADARTPOS can be filled correctly and USAGELOG contains useful information.

POSITIONS contain the English description of advertising positions, ARTICLES contain the title and ancillary information about articles the system manages, and ADVERTS contain the information necessary to display an advertisement.

ARTICLES may or may not have AUTHORS, but must have at least one TOPIC to be displayed in a table of contents. Some tracked articles will not have a topic because they are things like the table of contents itself or the home page.

ADVERTISERS may or may not have ADVERTS, but ADVERTS always have ADVERTISERS.

PARTNERS may or may not have restrictions on ARTICLES viewed when the system web site is entered with their source code, and may or may not have restrictions on ADVERTS for the same reason.

TOPICS may or may not have ADVERTS associated with them when a table of contents is displayed.

SUBSCRIBERS must have an PARTNER code. In addition, they may or may not have entries in the USAGELOG table.

It is important to note that FIG. 2 contains only the core tables necessary for running the system and that others, such as the KEYWORDS and KEYWORD advertising, CATALOG and it's related tables, and straight data verification tables (COUNTRY, PROVINCES) are not shown.

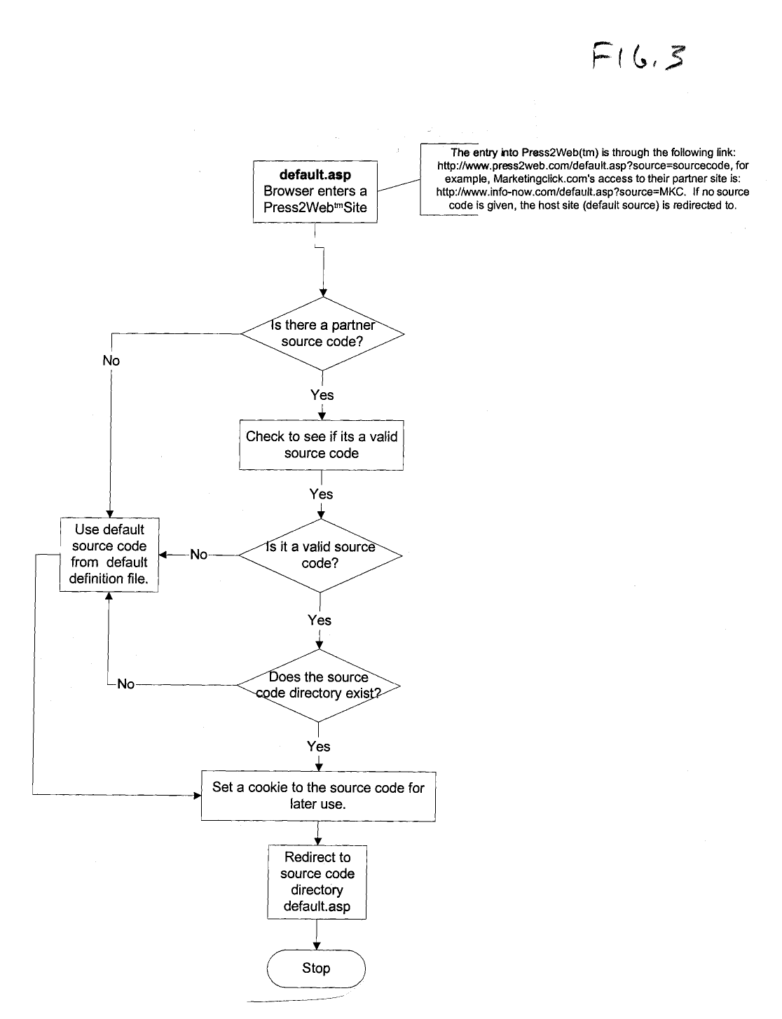

FIG. 3, relating to Initial Contact and Redirection, shows how the system reacts to contact through a browser. The system is contacted through two mechanisms: the first is with just the root web name and the second is with a passed source code.

Contacting via the root web name makes the system assume the default partner. For instance:
http://www.info-now.com
will result in the default partner for info-now site and will redirect to the directory on the site that contains the documents for info-now.com.
http://www.info-now.com/default.asp?source=MKC
will result in the Marketing Click site being displayed. Marketing Click is an internal partner, meaning that their content is on the same server.
When the system is contacted, it looks for that source code. If there is none, it jumps to the default partner site. The default partner site is set up when the system is initially installed.

If there is a source code passed, checks to see if it's a valid one for that site. If it is, it jumps to that partner's content. If it isn't the system jumps to the default site's content.

In all cases, whichever source code the system decides the incoming request is from, it sets a cookie so that it doesn't have to check again.

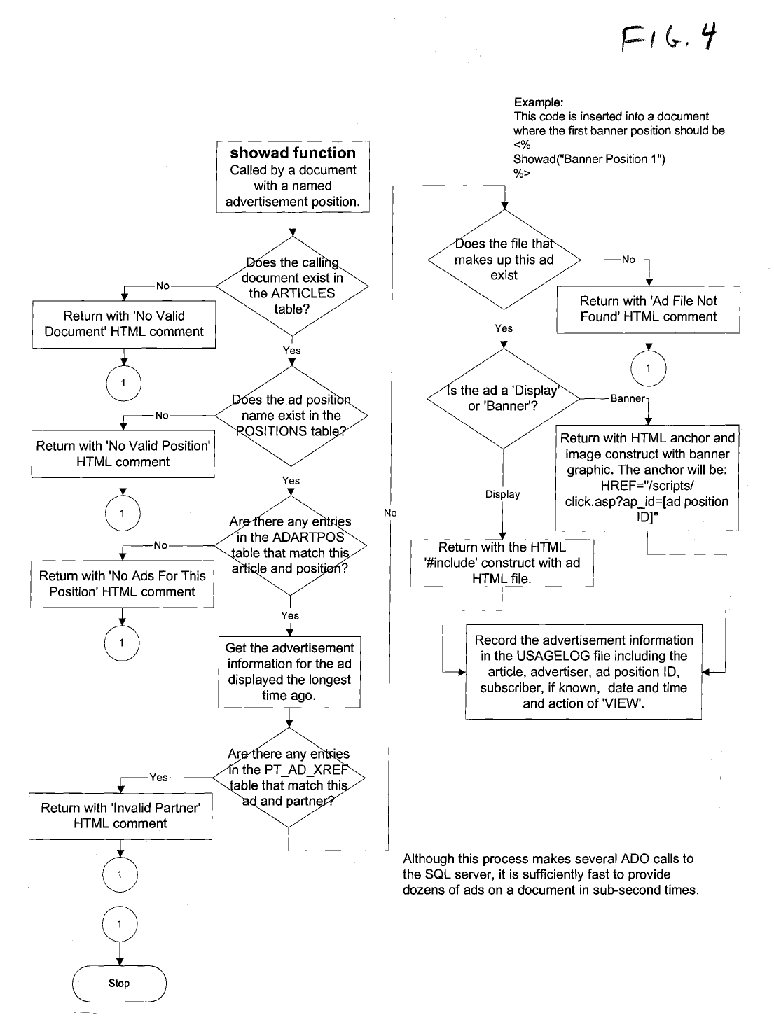

With reference to FIG. 4, Advertising Display, one of the system's core functions is to display advertisements and make it possible to track them. Any article that has an advertisement will have at least one entry in the code itself similar to the following:
<%=showad(“Banner Position 1”)5>
This tag indicates that the advertisement placed in this article at Banner Position 1 should be retrieved and placed here in the document. The system takes this request and validates it for ARTICLE name (it exists and is active in the article table), POSITION (it is a valid position name), and finally that there has been an ADVERT assigned this position in this article in the ADARTPOS table.

If any error condition occurs, then an advertisement is not served and a diagnostic comment is written to the browser (not seen, except in ‘view source’ of the browser document). The system then checks to see that the file that creates the advertisement exists. If not, it writes a diagnostic comment to the browser.

If the advertisement file exists, it is served with whatever links and alternate information it can supply from the ADVERTS table. Then Press2Web™ writes the fact that someone (if known, their PIN number) has seen the advertisement in USAGELOG.

The result is that the person browsing the document sees an advertisement and the fact is recorded.

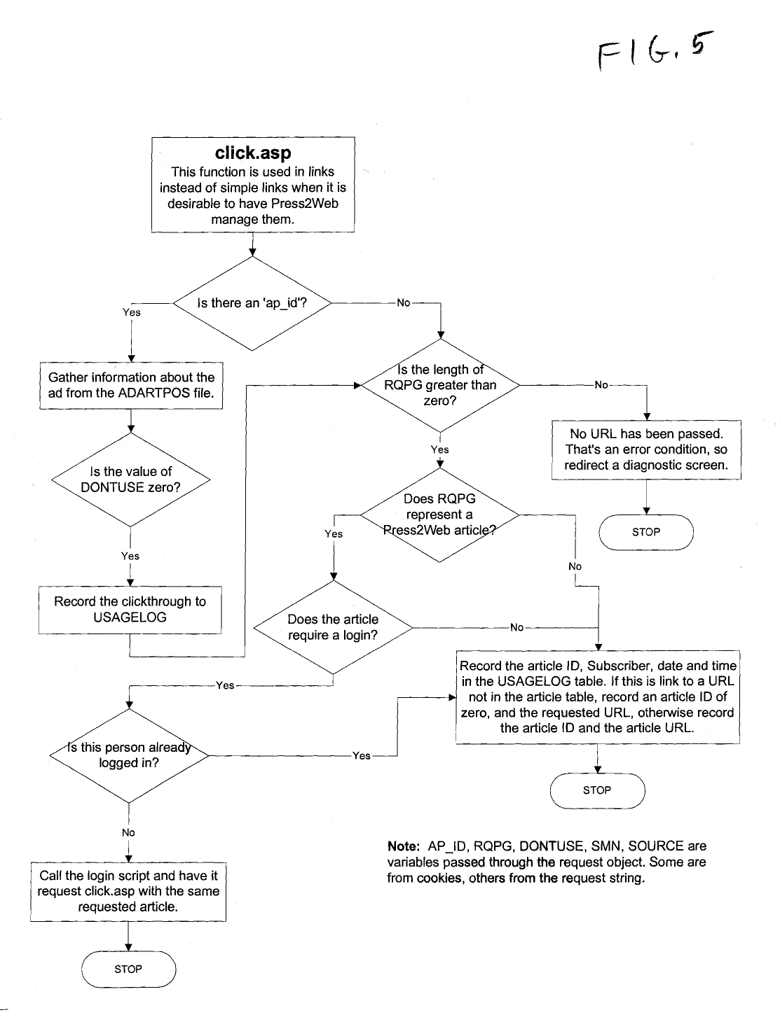

The flow logic for Click through recording is shown in FIG. 5. The click recording subsystem is the second major piece of the tracking system. Where the table of contents and advertisement display portions record what is passively seen, the click recording system records what has actively been done.

The system is called with a link in a document that can have two mutually exclusive parameters; an advertisement position key, and a URL.

In the event it is called with an advertisement position key, the system looks up in the ADARTPOS table for that key. It gathers all the information about the advertisement (advertiser ID, advertisement ID, where to go when clicked).

One feature is that a subscriber can be marked for not being recorded—their accesses are ignored. This is useful for subscribers that are owners or employees, or subscribers that have paid to not be recorded.

If the subscriber is known at this time, (they have logged in) and their ‘don't use’ flag is not set, the system will record their action as a click. If it is set, the system will just redirect the user to the URL gathered from the advertisement information.

If no advertisement position was passed, and a requested page was passed, the system will lookup the requested page in the ARTICLES table and determine if it represents an article that is tracked. If it is, and it requires a login, it will redirect the user to a page for logging in before calling itself again for processing.

If the system discovers that 1) the user is logged in and 2) the article requires a login OR the article doesn't require a login, it will record the appropriate information in USAGELOG and redirect the user to the new page.

If the system discovers that the requested page is not in the ARTICLES file, it will record the requested page in USAGELOG and redirect the user to the new page.

If neither an advertisement ID or requested page was passed, the system will display a diagnostic page. This will indicate that something is wrong and will indicate to the user what to do.

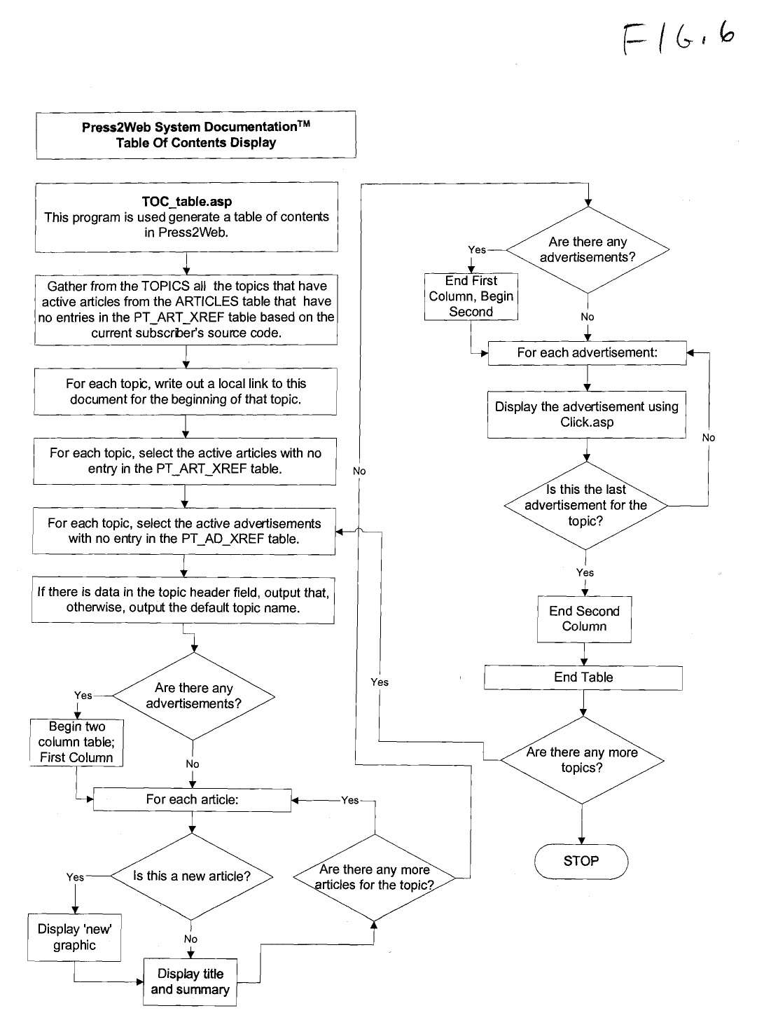

FIG. 6 shows the flow logic for Generating A Table of Contents. The table of contents tool (TOC tool) allows for the generation of a table of topics, and a table of contents that includes summaries for the articles as well as advertisements associated with topics.

First the TOC tool gathers all the topics from the TOPICS table that have active ARTICLES that can be viewed given the current user's partner code. The PT_ART_XREF table contains entries for articles that are NOT seen with the current partner code. The result is a set of topics for this partner that have articles to be displayed.

The system then displays the topics in a table as links to the summaries portion of the document.

The summaries portion of the document contains articles in alphabetic order by topic and title with their summaries and whatever advertisements are to be displayed in the table of contents.

Using the table generated at the beginning, the system gathers, by topic, all the article information necessary for creating links. It then generates the HTML code for displaying the information.

It should be noted that two things are true: If an article is assigned no topics, it will not show up in the TOC, and if it is assigned more than one topic, it will appear in more than one place.

If any advertisements are placed by topic, then the system will display them appropriately.

1. An online publishing management system comprising
A) at least one advertisement computer means for storing an advertisement file;
B) at least one article computer means for storing an article file; and
C) a publishing management server computer comprising:
(i) user interface means for receiving data from and sending data to a user;
(ii) database means for storing a plurality of database tables, said database tables comprising:
a) an advertisement table comprising a plurality of advertisement records, each advertisement record comprising information regarding an advertisement file stored on an advertisement computer means;
b) an advertiser table comprising a plurality of advertiser records, each advertiser record comprising information regarding an advertiser associated with at least one advertisement file stored on an advertisement computer means;
c) an article table comprising a plurality of article records, each article record comprising information regarding an article file stored on an article computer means; and
(iii) processing means adapted to:
a) generate a plurality of reports as a function of one or more of the database tables;
b) allow a user to input, via the user interface means, criteria for generating the reports;
c) provide the reports to a user via the user interface means; and
d) allow a user to enter or modify, via the user interface means, records in any of the database tables.

2. The online publishing management system of claim 1 wherein the database tables further comprise:
d) an author table comprising a plurality of author records, each author record comprising information regarding an author associated with at least one article file stored on an article computer means.

3. The online publishing management system of claim 1 wherein the database tables further comprise:
e) a partner table comprising a plurality of partner records, each partner record comprising information regarding a partner of the system.

4. The online publishing management system of claim 1 wherein the database tables further comprise:
e) a subscriber table comprising a plurality of subscriber records, each subscriber record comprising information regarding a subscriber of the system.

5. The online publishing management system of claim 1 wherein the processing means is further adapted to generate a composite article for publication to a subscriber; the composite article comprising an article file and at least one advertisement reference associated therewith.

6. The online publishing management system of claim 5 wherein the composite article is in HTML code, and wherein the associated advertisement reference is a resource locator of an advertisement associated with the composite article.

7. The online publishing management system of claim 6 wherein the resource locator of the associated advertisement is a URL.

8. The online publishing management system of claim 1 wherein the advertisement records each comprise an advertisement description field, a start field, an end field, an advertisement resource locator indicative of the location of the advertisement, a partner site permission field indicative of partner sites with which the advertisement may be displayed, and an article field indicative of the articles with which the advertisement has been associated.

9. The online publishing management system of claim 8 wherein the article field indicates a display position within the article that the advertisement will be displayed.

10. The online publishing management system of claim 8 wherein the advertisement record further comprises the advertisement file.

11. The online publishing management system of claim 1 wherein the article records each comprise an article description field, an article resource locator indicative of the location of the article, an active/inactive field indicating if the article is currently active, and a table of contents field indicating if the article should be included in a table of contents file.

12. The online publishing management system of claim 1 wherein the article records further comprise an advertisement display position field indicative of locations in the article in which an advertisement may be inserted.

13. The online publishing management system of claim 1 wherein the article records further comprise an author field.

14. The online publishing management system of claim 1 wherein the article records further comprise a topic field indicative of the subject matter of the article.

15. The online publishing management system of claim 1 wherein the article records further comprise a partner site filed indicative of partner sites on which the article may be associated.

16. The online publishing management system of claim 1 wherein the reports generated by the processing means comprise an advertiser contract report comprising a list of contract records for an advertiser of the system, the contract records comprising a description of the advertiser, a description of the advertisement associated with the advertiser, a field indicative of the start date and the end date of the advertisement, and a filed indicating an article that the advertisement is associated with and the display position within that article.

17. The online publishing management system of claim 1 wherein the reports generated by the processing means comprise an advertiser lead report comprising a list of advertiser lead records, each advertiser lead record comprising an identification of a subscriber, a list of articles previously accessed by that subscriber within a defined time period, and a list of advertisements associated with those articles previously accessed by that subscriber within a defined time period.

18. The online publishing management system of claim 1 wherein the reports generated by the processing means comprise an article usage report comprising a list of articles and the number of subscribers that accessed each article in a given time period.

19. The online publishing management system of claim 1 wherein the reports generated by the processing means comprise an article activity report comprising a list of articles and activity statistics, the activity statistics comprising the number of times the article was viewed, the number of times the article was printed, and the number of times the article was emailed.

20. The online publishing management system of claim 1 wherein at least one advertisement computer means for storing an advertisement file is located on the publishing management server computer.

21-46. (canceled)
